(19) United States
(12) Patent Application Publication
(10) Pub. No.: US 2023/0316240 A1
(43) Pub. Date: Oct. 5, 2023

(54) TIP COLLECTION FUNCTION FOR A CONFIGURABLE PARTICIPANT-INPUT PORTAL

(71) Applicant: Peek Travel Inc., San Francisco, CA (US)

(72) Inventors: Lisa McLean, Seattle, WA (US); Oskar Bruening, San Francisco, CA (US); Navya Rehani, San Francisco, CA (US); Javier Jacome, Bayonne, NJ (US); Anthony Dam, Seattle, WA (US)

(21) Appl. No.: 17/708,961

(22) Filed: Mar. 30, 2022

(51) Int. Cl. G06Q 20/08; G06Q 30/02

(52) U.S. Cl. CPC G06Q 20/0855; G06Q 30/0283

(57) ABSTRACT

Devices, systems, methods, and computer-readable media for providing by a third party device a tip collection function to an activity operator to collect a tip from a participant. One method includes using the tip collection function to offer to a plurality of participants, by the activity operator, a portal to allow the participants to each pay a tip for a service. A method further includes paying, to the third party via a portal, the tip by each participant electing to pay the tip and aggregating, by the third party, a plurality of tips from the plurality of participants electing to pay the tip over a period of time. A method further includes paying, by the third party, the aggregated plurality of tips from the plurality of participants to the activity operator.

### FIELD OF THE PRESENT DISCLOSURE

Devices, systems, methods, and computer-readable media for providing to a prospective activity participant a tip collection function for a configurable participant-input portal. In particular, the present application describes concepts involving tip collection by a third party via a configurable participant-input portal, wherein the participant-input portal is configured by the activity operator via an activity operator-input portal that is created by a third party and accessible through a third party device, and information about an activity is configured to indicate to the prospective activity participant that the activity is available during a particular day and time that is configured by the activity operator.

### BACKGROUND

People enjoy participating in a variety of activities. These activities could be local activities or activities that require travel. Such activities could also be a variety of different kinds of activities and can include tours. The activities may include, but are not limited to, sightseeing tours, food tours, vehicle tours or rentals, such as by boat, car, bus, bicycle, Segway, scooter, etc., and other activities organized by an organizing entity wherein a participant will need to sign up to participate or sign up to reserve equipment with that organizing entity. As technology has changed, people have used different avenues to search for and reserve spots for tours.

As the Internet has grown, it has made many aspects of people's lives easier and more convenient. Booking tours is one of those aspects. Websites have been created for the purpose of helping people search for and book tours. Some of these websites can be referred to as activity booking portals. Activity booking portals allow people to search for and book different activities.

Activity booking portals add convenience for participants. One way activity booking portals add convenience to participants is that it allows participants to more easily find tours. This is accomplished by allowing participants to search for the type of tour they want. Activity booking portals allow participants to search for a type of tour, location of a tour, price of a tour, duration of a tour, etc. Some activity booking portals also allow people to write participant reviews and read reviews from other participants. In this regard, many activity booking portals provide participants with a convenient website to conduct various aspects of planning and booking activities.

These activity booking portals also provide convenience for the tour operators. Putting their tours on these activity booking portals allows more potential participants see their tours than if the tour operator only had the tour viewable on its own private website and promotional materials. As a result of having more people view the tour listing, activity booking portals allow the tour operator to inform more people about the tours available and what occurs during each type of tour. This may attract participants to a specific tour that were not originally looking for that specific tour.

### BRIEF DESCRIPTION OF THE DRAWINGS

FIG. 1 illustrates a functional block diagram of a computing system including at least one memory array featuring instructions for a tip collection function for a configurable participant-input portal configured according to embodiments of the present disclosure.

FIG. 2 is a screenshot of tour operator-configurable parameters for tips displayed on the activities booking portal configured according to embodiments of the present disclosure.

FIG. 3 is a screenshot of payment options displayed on the activities booking portal configured according to embodiments of the present disclosure.

FIG. 4 is a screenshot of a service provider list displayed on the activities booking portal configured according to embodiments of the present disclosure.

FIGS. 5A-5B are screenshots of a report displayed on the activities booking portal configured according to embodiments of the present disclosure.

FIG. 6 illustrates a flow diagram of an example method for a tip collection function for a configurable participant-input portal configured according to embodiments of the present disclosure.

### DETAILED DESCRIPTION

The embodiments of the present disclosure describe a tip collection function for a participant-input portal. As used herein, “tour”, “activity”, or “service” are used interchangeably to describe any activity organized by an organizing entity wherein a participant will need to sign up to participate or sign up to reserve equipment with that organizing entity. Examples include: boat tours, multiple water sports, sailing classes, boat rentals, bike tours, cannabis tours, coach tours, food and/or drink tours, ghost tours, photo tours, Segway tours, walking and/or running tours, farm tours, helicopter tours, plane tours, horseback riding tours, hot air balloon tours, and other activities organized by an entity such as flyboarding, jetpacking, hang gliding, paragliding, kayaking, standup paddle boarding, surfing, kiteboarding, outdoor activities, rafting, scuba diving, snorkeling, waterskiing, wakeboarding, ferries, ziplining, skydiving, track experiences, boat charters, fishing charters, escape rooms, rage rooms, axe throwing, visiting a cat café, paintballing, art classes, cooking classes, tasting classes, dance classes, fitness classes, flying lessons, life skills classes, skiing, snowboarding, visiting a brewery, visiting a winery, visiting a distillery, visiting a casino, visiting a golf course, visiting a gun range, playing laser tag, playing mini-golf, using a transportation service, visiting a trampoline park, going to a theater, using a limo service, participating in an animal encounter, visiting a karting center, visiting a museum, visiting a historic site, etc.

More specifically, the embodiments describe a tip collection function for a participant-input portal that allows activity operators to collect and distribute tips paid by participants of an activity. These conditions allow for tips to be paid by participants to the third party and then be tracked from the moment they are paid to the third party to the moment they are distributed to the activity guides.

This adds convenience for activity operators because this allows the activity operator to track tips paid by activity participants without having to manage the participant payment of the tip in person and/or without the activity operator having to manually collect and distribute tips to the activity guides. Through embodiments of the present disclosure, tips can also be aggregated and paid periodically rather than when each tip is paid which can allow for larger blocks of uninterrupted time for the activity operator to accomplish other tasks.

Accordingly, devices, systems, methods, and computer-readable media are discussed herein for providing, by a third party device, a tip collection function for a participant-input portal, wherein the tip collection function allows an activity operator to collect a tip from a participant. As used herein, a “service party” or “activity operator” are used interchangeably to describe any person or entity that configures a participant-input portal and facilitates the operation of the activity associated with the activity listing displayed on the participant-input portal.

One method includes providing, by a third party device, a tip collection function for a participant-input portal that allows an activity operator to collect a tip from a participant. As used herein, the term “third party device” refers to computing devices such as server computing devices, desktop computers, laptop computers, personal computers, mobile telephones, PDAs, and the like that are not operated or controlled by the activity operator or activity participant. In such a system, the third party creates a set of input portals (activity operator-input portal and activity participant-input portal) that allow the activity operator to access third party created tools to customize an activity participant-input portal via the activity operator-input portal.

The method further includes using the tip collection function to offer to a plurality of participants, by the activity operator, an activity participant-input portal to allow the participants to each pay a tip for a service. Allowing the participants to each pay a tip for a service includes allowing the participant to each pay the tip in multiple ways.

The method further includes paying to the third party, via the activity participant-input portal, a tip by each participant electing to pay a tip. Additionally, a method can include aggregating, by the third party, a plurality of tips from the plurality of participants electing to pay a tip over a period of time. Further, a method can include paying, by the third party, the aggregated plurality of tips from the plurality of participants to the activity operator.

In some embodiments, the tip collection function allows a participant-input portal in which the tip collection function is implemented to collect tips before participating in an activity or after participating in an activity. For example, a participant can pay a tip as the participant is booking the activity or, more likely, after the participant participates in the activity. In some embodiments, the participant can pay a tip in a variety of currencies, including a credit card on file with the activity booking portal, and assign the paid tip to a specific activity guide or service provider (e.g., helpful dock attendant employed by the activity operator). In some embodiments, a participant's tip can be associated with the participant's initial activity purchase. For example, when paying a tip after participating in the activity, the tip can be added to the initial activity purchase, thereby providing only one purchase amount (e.g., charge on a credit card) for the activity.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure.

As used herein, “a number of” something may refer to one or more such things. For example, a number of activity vehicle options may refer to at least one activity vehicle option.

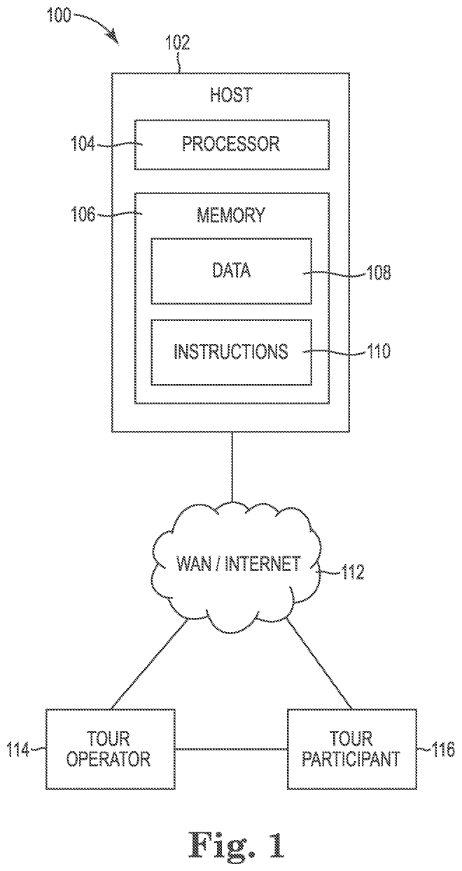

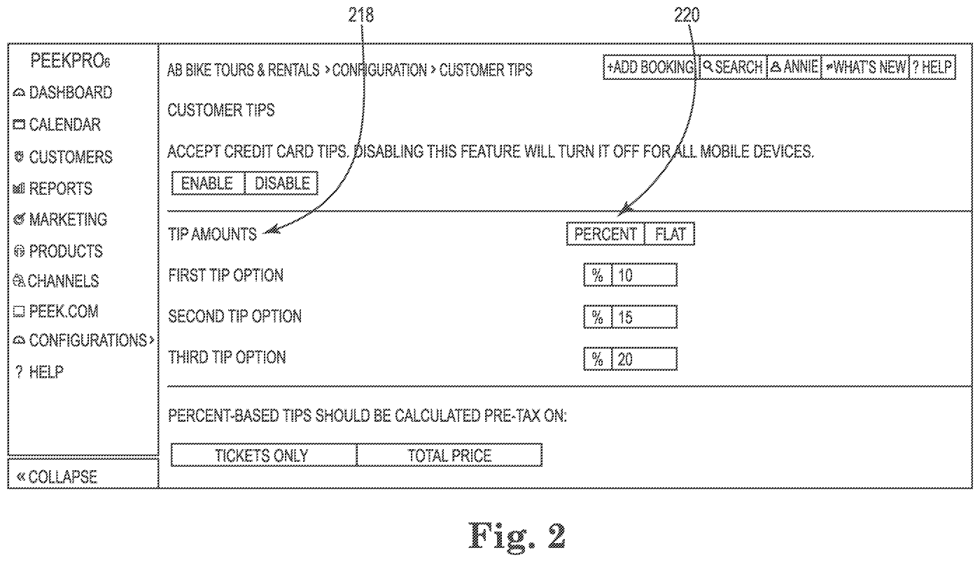

The figures herein follow a numbering convention in which the first digit or digits correspond to the figure number of the drawing and the remaining digits identify an element or component in the drawing. Similar elements or components between different figures may be identified by the use of similar digits. For example, reference numeral 104 may reference element “04” in FIG. 1, and a similar element may be referenced as 204 in FIG. 2.

FIG. 1 illustrates a functional block diagram of a computing system including at least one memory array featuring instructions for a weight balancing function for a configurable activity participant-input portal in accordance with a number of embodiments of the present disclosure. System 100 includes a computing device (e.g., a host 102) which features a processor 104 and memory 106. In some embodiments, the host 102 can be the third party computing device. The memory 106 includes information stored therein in the form of data 108 and/or executable instructions 110 that are executable by the processor. The data can be used or analyzed by the executable instructions to, for example, produce reports, analyze data to solve problems, such as weight balancing, or determine if software (also comprised of executable instructions) needs to be adjusted. System 100 also includes a connection to a wide area network (WAN) (e.g., the Internet 112), an activity operator-input portal 114 (e.g., accessed by an activity operator through an activity operator's computing device), and an activity participant-input portal 116 (e.g., accessed by an activity participant through an activity participant's computing device). In some embodiments, the third party device 102 (e.g., host) can host the activity operator-input portal 114 and the activity participant-input portal 116 on the third party device placing the access functionalities of the activity operator-input portal 114 and the activity participant-input portal 116 on the third party device 102.

The third party device 102 can include an interface, such as a touch screen, number pad, keyboard, or other method of interface to allow the third party to enter data into the third party device. Further, a host functionality can be implemented on the third party device such that the host functionality allows the third party device to provide the tip collection function for the activity operator.

In some embodiments, a host 102 may include a processor 104. As used herein, “a processor” may be a number of processors, such as a parallel processing system, a number of coprocessors, etc. Example hosts may include, or be implemented in, server computing devices, desktop computers, laptop computers, personal computers, mobile telephones, PDAs, and the like. Such a host 102 may be associated with a configurable software engine for automatically updating portions of a portal or tools used to create or customize a portal.

The processor 104 may execute instructions stored in a memory (e.g., memory 106) for providing a tip collection function on an activity participant-input portal. In some embodiments, the activity participant-input portal acts as an activity booking portal. In some embodiments, the activity participant-input portal is an activity equipment booking portal. The activity participant-input portal may display a variety of activity or equipment listings. A configuration engine may be created by the third party, made available for access by the third part computing device, and may be used by the activity operator to modify the participant-input portal to customize the participant-input portal based on the selections made by the activity operator.

Once the participant-input portal is customized and configured to allow access by participants, the participants may purchase spots for activities using the participant-input portal, or participants may purchase the spots for activities by contacting the activity provider (activity operator) directly and the activity operator may enter the purchase details into the activity participant-portal on behalf of the activity participant. As used herein, a participant input portal may refer to a system that that serves as the interface where a participant may make purchases.

In serving as that interface, the participant-input portal may include a variety of features for the convenience of the participant and an activity operator. For example, in some embodiments, the participant-input portal may include activity listings in which portions of the activity listings can be automatically modified by a configuration engine.

The host 102 can execute instructions 110 stored in the memory 106 to provide, by a third party device, a tip collection function for an activity operator to collect a tip from a participant.

As mentioned above, in some embodiments, the tip collection function can accept payment of a single tip in multiple currencies. For example, payment of a single tip can be paid by a credit card, cash, vouchers, or a combination thereof. Further, payment of a single tip can be paid by multiple credit cards, cash from multiple participants, multiple vouchers, or a combination thereof. Further, the tip collection function allows participants to choose to assign a different flat fee in each of multiple currencies when paying a single tip.

The activity operator can use the configuration engine to configure the participant-input portal to display the different tip payment options to the activity participant. The activity operator can further configure the participant-input portal to accept an input from an activity participant corresponding to a tip payment option and accept payment of a tip from the activity participant based on the selected tip payment option.

The host 102 can execute instructions 110 stored in the memory 106 to integrate the tip collection function into the activity participant-input portal to allow one or more participants to each pay a tip for a service. Further, the host 102 can execute instructions 110 stored in the memory 106 to use the tip collection function to pay, to the third party via the participant-input portal, the tip by each participant electing to pay the tip. As used herein, the term “third party” refers to the person or entity that owns and/or operates the configuration engine that allows the activity operator to configure the participant-input portal. In some embodiments, the tip paid by the participant can be received by the third party and then disbursed to the activity operator. The activity operator can then disburse the tips paid by the participants to the service providers. The terms “service provider” and “activity guide” are used interchangeably to describe someone who leads a tour or activity.

The host 102 can execute instructions 110 stored in the memory 106 to use the tip collection function to aggregate, by the third party, a plurality of tips from the plurality of participants electing to pay the tip over a period of time. In some embodiments, the amount of time over which the tips are aggregated can be determined by either the third party or the activity operator. The host 102 can further execute instructions 110 stored in the memory 106 to use the tip collection function to pay, by the third party, the aggregated plurality of tips from the participants to the activity operator. The activity operator can disburse the aggregated tips to one or more service providers.

Some prior activity booking sites may not allow activity participants to enter a tip neither before participating in an activity nor after participating in the activity. When booking an activity through one of these activity booking sites, a participant may have had to tip the activity guide in person if the participant elected to leave a tip. This added an inconvenience to the activity operator when the activity operator wanted to track the tips being paid to the activity guides because the tip was being paid directly to the activity guide and, therefore, the activity operator must rely on the activity guide to provide accurate information about the amount of tips received by the activity guide. Also, this added an inconvenience for participants that wanted to tip their activity guide but did not have an amount of cash on their person that they would like to tip the activity guide. These inconveniences can be eliminated by implementing the tip collection function into the participant-input portal according to the embodiments of the present disclosure.

The tip collection implemented into the participant-input portal, as described herein, gives the activity operator more control over how tips are collected than previous approaches. For example, the third party can provide customization options wherein the activity operator can configure the configuration engine to allow multiple tipping options to be displayed on the participant-input portal. The tipping options that an activity operator can configure the configuration engine to display on the participant-input portal can include, at least, options for a prospective activity participant to tip before and/or after participating in an activity, adding a tip to a payment for an activity after the participant spot for the activity has been purchased, allowing a single tip to be paid with multiple currencies, and allowing multiple participants to pay a single tip. Configuring the configuration engine allows the activity operator the ability to adjust the tipping options to the activity operator's preferences.

Further, implementing the tip collection function into the participant-input portal as disclosed herein can, in some embodiments, give the activity operator access to a report that includes details about the tips that were paid via the participant-input portal. Details included in the report include, for example, at least one of: an aggregate amount of tips paid over a period of time, a status of tips assigned to different activity guides, and a transaction history of tips paid to different activity guides. The activity operator can use the information included in the report to decide how to disperse the paid tips to the activity guides.

FIG. 2 is a screenshot of activity operator-configurable parameters for tips displayed on the activities booking portal. In some embodiments, the parameters 220 for tips can include, at least one of: a percentage of a cost of an activity, a percentage of a total cost of the activity and add-ons to the activity, and a flat rate.

In some embodiments, as shown in FIG. 2, the tip collection function can allow an activity operator to choose whether a tip amount 218 is determined based on a percentage or a flat rate. In other embodiments, an activity operator-input portal can allow a participant and/or service provider to choose whether a tip amount 218 is determined based on a percentage or a flat rate. As used herein, the term “flat rate” refers to an amount for a tip that is not determined based on a percentage of the price of an activity or piece of equipment.

In some embodiments, an activity operator can determine whether the participant pays a tip based on a percentage of a price of an activity or a percentage of a total price of the activity and add-ons to the activity. In other embodiments, a participant and/or service provider can determine whether the participant pays a tip based on a percentage of a price of the activity or a percentage of a total price of the activity and add-ons to the activity. As used herein, the term “add-ons” refers to additional items that can be purchased in relation to an activity. For example, add-ons can include, at least one of: optional equipment for use during the activity, merchandise, food, and beverages. In some embodiments, the determination of whether the tip amount 218 includes a percentage of the cost of the add-ons to the activity is based on the type of add-ons to the activity. For example, if the add-ons include merchandise, the activity operator may not want the participant to include the price of the merchandise when determining the tip amount 218. However, if the add-ons include food and beverages, the activity operator may want the participant to include the price of the food and beverages when determining the tip amount 218. If the add-ons include merchandise, as well as food and beverages, in some embodiments, the price of the add-ons can be split such that the price of the food and beverages can be included when determining the tip amount 218, but the price of the merchandise is not included when determining the tip amount 218.

In some embodiments, such as that shown in FIG. 2, the tip collection function can provide multiple options for determining a tip amount 218 when the participant determines the tip amount 218 based on a percentage. For example, the tip collection function can provide different options corresponding to different percentage values when determining the tip amount 218. In the example shown in FIG. 2, the tip collection function provides the option to determine the tip amount 218 by based on a first option (e.g., ten percent), a second option (e.g., fifteen percent), or a third option (e.g., 20 percent). In some embodiments, an activity operator or a service provider can determine which percentage values correspond to the first option, the second option, and the third option. In some embodiments, a participant can choose a percentage value to determine the tip amount 218 that does not correspond to the first option, the second option, or the third option.

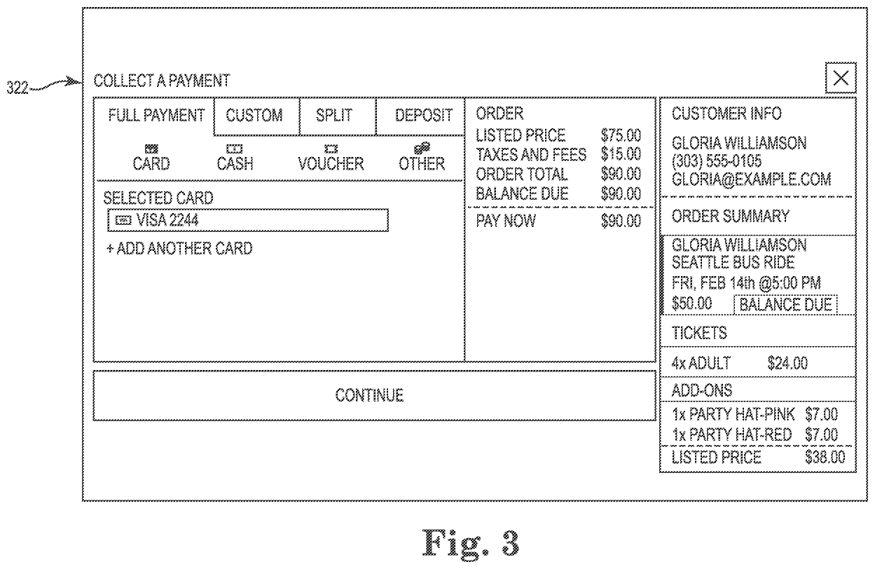

FIG. 3 is a screenshot of payment options displayed on the activities booking portal. As stated earlier, the tip collection function allows a participant to tip either before the participant participates in an activity or after the participant participates in the activity. In some embodiments, a service provider can select whether the participant pays a tip before participating in the activity or after participating in the activity. If a participant pays a tip before participating in the activity, the participant can pay the tip while the participant is paying for the activity. Further, when the participant pays the tip before participating in the activity, the participant may enter payment information for the activity before paying the tip for the activity.

The POS system in which the tip collection function is implemented can include a payment collection interface 322. As shown in FIG. 3, the payment collection interface 322 can include payment options, a price of the activity, participant information, and/or an order summary. In some embodiments, the payment options can include paying by credit card, debit card, cash, voucher, or other sources of payment. In some embodiments, a participant can pay a tip using a different currency (e.g., payment option) than the currency the participant used to pay the price of the activity. For example, a participant can pay for an activity using a voucher and pay the tip for the activity using a credit card. In some embodiments, the participant can pay the tip using a credit card that is already on file (e.g., the credit card's information is already saved in the POS system in which the tip collection function is implemented) or pay with a credit card that is not on file.

In some embodiments, the payment collection interface 322 can include a price of the activity. As shown in FIG. 3, the payment collection interface 322 can include a listed price, taxes and fees, and a total price of activity. In some embodiments, the total price of an activity, including the listed price as well as the taxes and fees, as shown in the payment collection interface 322 of FIG. 3, can be used to determine the amount of a tip paid by a participant.

In some embodiments, the payment collection interface 322 can include participant information and/or an order summary. As shown in FIG. 3, the participant information can include the participant's name, phone number, and/or email address.

As further shown in FIG. 3, the order summary can be associated with the participant. For example, the order summary, which includes the name of an activity, date of an activity, time of an activity, and/or price of an activity, can be associated with the participant that purchased the activity.

Further, the order summary can include an itemization of the costs that comprise the total cost of an activity. For example, FIG. 3 shows an itemization of a bus ride that includes four adult tickets that costs a total of $24 and add-ons that include two party hats that cost $7 each. The sum of the adult tickets and the add-ons results in a list price of $38. Not shown in FIG. 3 are the taxes and fees which brings the total price of the bus ride to $50. Further, the order summary can display the status of the payment for the activity. In the example shown in FIG. 3, the cost of the bus ride has not yet been paid.

In some embodiments, the order summary can be a part of an order that is associated with a participant. For example, as stated above, a participant can pay for an activity and then add a tip for that activity to the order at a later time after participating in that activity. Further, the participant can add a subsequent activity to an order. For example, a participant can order and pay for an activity and then add a subsequent activity to the order after a period of time has passed since the participant booked and paid for the previous activity.

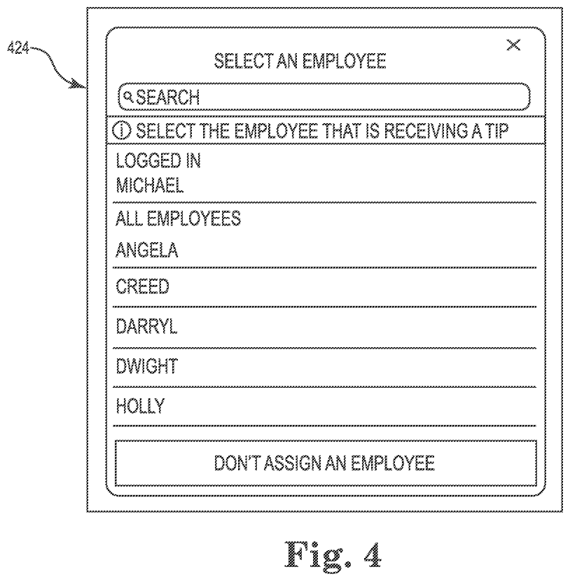

FIG. 4 is a screenshot of a service provider list 424 displayed on the activities booking portal. As stated earlier, when a participant pays a tip for an activity at the time of paying for the activity, the participant can pay the tip using a payment collection interface described in connection with FIG. 3. In some embodiments, after the participant pays the tip to the third party, the service provider or other activity operator employee can choose one or more service providers from a service provider list 424 to receive the tip, such as the particular provider that provided the service to the participant, to a team of service providers that provided service to the participant, or to all service providers, among other service provider designations. Similarly, in some embodiments, the service provider or other activity operator employee can choose a service provider from the service provider list 424 to receive the tip before the participant pays the tip.

As shown in FIG. 4, the tip collection function can include a service provider list 424 that shows which service providers might be eligible to receive a tip. In some embodiments, the service provider list 424 can be associated with an account of the activity operator, wherein the account is associated with the activity booking portal that implements the tip collection function of the POS system. The service provider list 424 can include a status of the service providers. The status of the service providers can include, for example, whether the service provider is currently logged in to the POS system in which the tip collection function is implemented. In some embodiments, an indication that a service provider is logged in can also be an indication that the service provider is actively interacting with the tip collection function. Therefore, in some embodiments, an indication that a service provider is logged in can also be an indication that the logged-in service provider is currently selecting which service provider from the service provider list 424 will receive a tip that has been paid by a participant or a tip that will be paid by the participant.

In some embodiments, a service provider can choose not to select a service provider from the service provider list 424 to receive a tip. As shown in FIG. 4, the service provider list 424 can include an option not to assign a tip to a service provider. If the service provider chooses not to assign a tip to a service provider from the service provider list 424, the tip can be aggregated with other tips within the tip collection function and then disbursed to the service providers by the activity operator that pays the service providers.

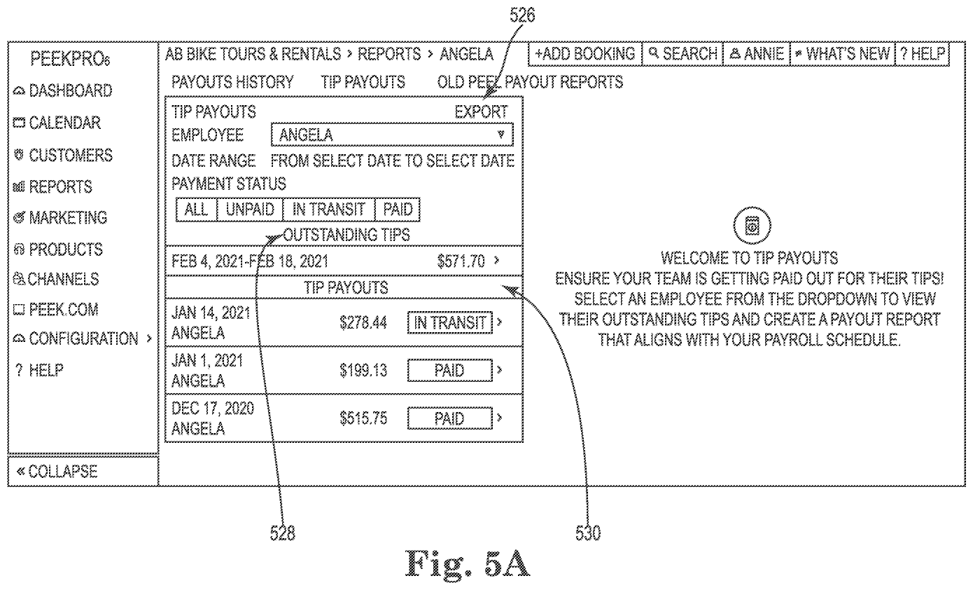

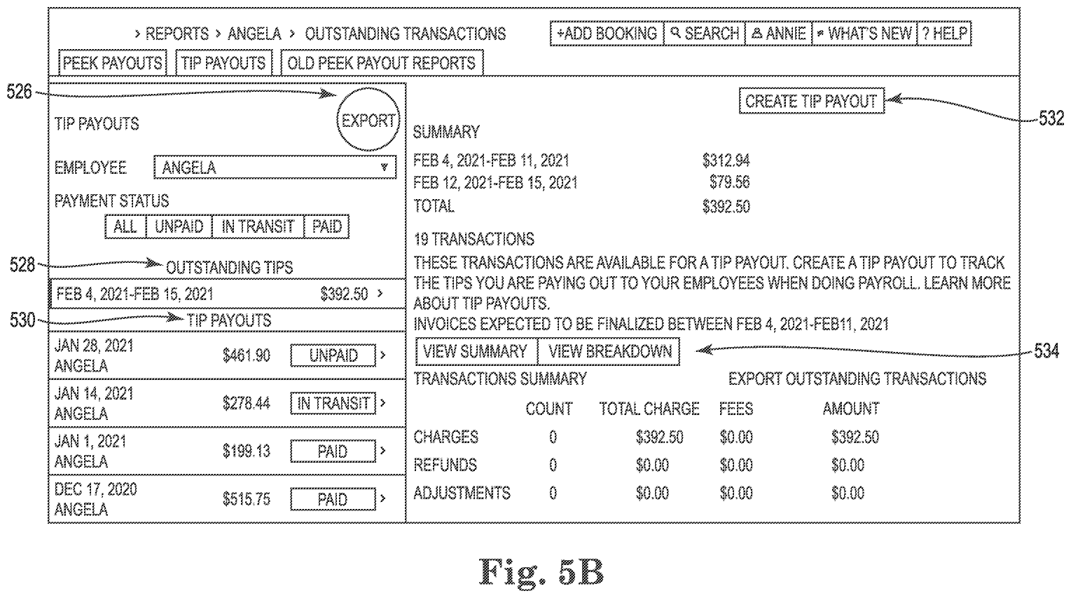

FIG. 5A is a screenshot of a report displayed on the activities booking portal. In some embodiments, the activity operator can use the tip collection function to access the report. The tip collection function can, for example, include a report that includes an export button 526, an outstanding tips section 528, and/or a tip payouts section 530. In some embodiments, the export button 526 can be used to see a variety of options for exporting (e.g., disbursing) tips to the service providers. The options for exporting the tips can include, for example, exporting the tips to one service provider at a time or exporting the tips to multiple service providers simultaneously.

As shown in FIG. 5A, a tip collection function can provide, to the activity operator, a report that includes information about a status of the tips. In some embodiments, the status of the tips can include an amount of outstanding tips, wherein the amount of outstanding tips includes tips paid to the third party that have not been disbursed to each of a plurality of service providers by the activity operator. In some embodiments, the outstanding tips section 528 can include the aggregated amount of tips. As shown in FIG. 5A, the outstanding tips section 528 can show the time period over which the outstanding tip amount has been aggregated. In these embodiments, the outstanding tips section 528 shows the amount of tips that will be disbursed to one or more service providers. In other embodiments, the outstanding tips section 528 can show the amount of tips that will be disbursed to a service provider who is currently being displayed on the report. In some embodiments, the tips can be disbursed to the service providers by the third party. In other embodiments, the tips can be disbursed to the service providers by the activity operators.

As shown in FIG. 5A, the report can include a tip payouts section 530. The tip payouts section 530 can show the status of tip payouts that have been disbursed to the service providers. In some embodiments, the status of the tip payouts can include, at least one of: the tips have not been paid to each service provider, the tips are in transit to each service provider, and the tips have been paid to each service provider. If a tip payout status indicates that a tip has not been paid, this indicates that a tip amount that has been assigned to a service provider has not yet been disbursed to that service provider. If a tip payout status indicates that a tip is in transit, this indicates that a tip amount that has been assigned to a service provider has been disbursed to the service provider but has not yet been received by the service provider. As stated previously, an activity operator can use the tip collection function to disburse a tip amount to a service provider. Further, if a tip payout status indicates that a tip has been paid, this indicates that a tip amount that has been assigned to a service provider has been disbursed to the service provider and received by the service provider.

FIG. 5B is another screenshot of a report displayed on the activities booking portal. In some embodiments, the activity operator can use the tip collection function to access the report. FIG. 5B includes an export button 526, an outstanding tips section 528, and a tip payouts section 530, as described in connection with FIG. 5A. FIG. 5B can further include a create tip payout button 532 and/or a transaction summary 534.

In some embodiments, the create tip payout button 532 can create custom tip payouts. The custom tip payouts in the report can include the name of the service provider (e.g., employee) to which a tip may be disbursed, an outstanding tips section 528 to show an amount of tips that have been collected but not yet disbursed, and/or a tip payouts section 530 to show the status of tips disbursed to a service provider. In some embodiments, the status of the tips can include the dates on which the tips were paid to each of the service providers. The custom tip payout can also include a summary of the tips that have been aggregated to form the amount of outstanding tips in the outstanding tips section 528. For example, as shown in FIG. 5B, the custom tip payout can include a summary that shows the range of dates over which the tips have been aggregated and/or the total amount of the aggregated tips. Further, the custom tip payout of the report can display a total number of transactions that contributed to a total amount of outstanding tips that are available to disburse to a service provider.

As shown in FIG. 5B, the report can also include a transaction summary 534. The transaction summary 534 can include the number of charges that comprise the amount of outstanding tips, fees associated with the total tip amount, the number of refunds, the refund amount, and/or adjustments. Further, the transaction summary 534 of the report included in the tip collection function can determine which transactions are available for a tip payout.

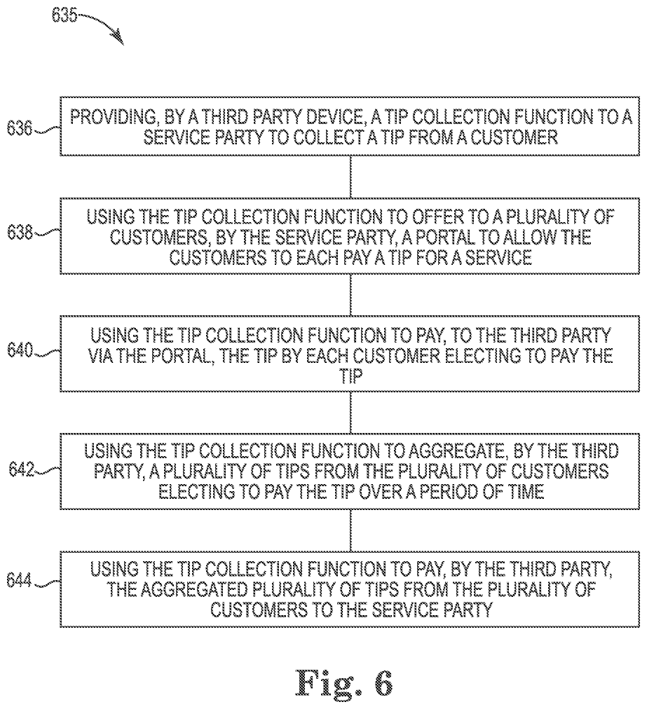

FIG. 6 illustrates a flow diagram of an example method 635 for a tip collection function for a configurable activity operator-input portal. Unless explicitly stated, elements of methods described herein are not constrained to a particular order or sequence. Additionally, a number of the method embodiments, or elements thereof, described herein may be performed at the same, or at substantially the same, point in time.

At block 636, the method 635 includes providing, by a third party device, a tip collection function to an activity operator to collect a tip from a participant. In some embodiments, the activity operator can determine the parameters of the tip. As stated previously, the parameters of the tip can include, at least one of: a percentage of a cost of an activity, a percentage of a total cost of an activity and add-ons to an activity, and a flat rate. The activity operator can configure the participant input-portal to display parameters of the tip such the participant, via the participant input-portal, can select a parameter of the tip and pay the tip to the third party based on the selected parameter. In some embodiments, the activity operator can configure the participant-input portal to only display the parameters of the tip that the activity operator chooses to make available to the participant.

In some embodiments, a participant can access the tip collection function of the POS system using a mobile device. That mobile device might include a camera. In some embodiments, when a participant signs to confirm the payment of a tip, the POS system can access the camera of the mobile device. The camera can then take a picture of the participant or other participant identifier when the participant signs to confirm the payment of the tip. The picture of the participant can be saved as an attachment to the booking of the activity for which the participant is confirming the payment of the tip.

At block 638, the method 635 can include using the tip collection function to offer to a plurality of participants, by the activity operator, a portal to allow the participants to each pay a tip for a service. The participant electing to pay the tip can pay the tip based on the parameters of the tip, created by the third party via the third party computing device and set by the activity operator, through the portal. In some embodiments, the activity operator and/or service provider can provide, to the participant, access to the portal to select tipping options provided by the activity operator and/or service provider.

At block 640, the method 635 can include using the tip collection function to allow the participant to pay, to the third party via the portal, the tip by each participant electing to pay the tip. When the participant pays a tip using the tip collection function, the payment for the tip is received by the third party, instead of the service provider for which the tip is intended. In these embodiments, the service provider can select whether the tip will be aggregated with other tips before the tips are disbursed to the service providers (e.g., pooling of tips to be shared equally by activity operator staff or holding tips for a period of time and then disbursing them to the service providers to which they were originally designated). If the service provider selects a service provider to receive the tip, the tip may not be aggregated by the third party before the tip is disbursed to the activity operator. If the service provider selects not to assign the tip to a specific service provider, the third party may aggregate all paid tips over a period of time before they are disbursed to the service providers.

At block 642, the method 635 can include using the tip collection function to aggregate, by the third party, a plurality of tips from the plurality of participants electing to pay the tip over a period of time. In some embodiments, the activity operator can select whether the tips are paid directly to service providers from the third party or the tips are aggregated and then an aggregated sum is paid to the activity operator to be disbursed to a plurality of service providers.

At block 644, the method 635 can include using the tip collection function to pay, by the third party, the aggregated plurality of tips from the plurality of participants to the activity operator. In some embodiments, the activity operator can determine an amount of the tips to pay each of the service providers. Every tip can be associated with the activity the tip is being applied to in the POS system in which the tip collection function is implemented. Therefore, even when tips for multiple service providers have been aggregated, the activity operator can determine which tips are intended for which service provider by determining which service providers facilitated the activity associated with every tip.

If the tips are unassigned and aggregated before being disbursed, the tips can be disbursed based on the number of service providers and the roles of the service providers. For example, as the aggregated tips are being disbursed amongst a higher number of service providers, each service provider receives a smaller portion of the aggregated tips. Further, different service providers can have different roles during an activity and the portion of the aggregated tips each service provider receives can depend on the role of the service provider. For example, a service provider that acts as an activity guide can receive a greater portion of the aggregated tips than an activity provider that acts as support staff for the activity guide. As used herein, the term “support staff” refers to people who work for an organization and support the people involved in the organization's main business. In this context, support staff can be anyone who manages rental equipment, helps collect payment for an activity, or performs any other action to help facilitate an activity except for being the activity guide.

To accomplish such a function individual service providers or groups of service providers can be ranked in a hierarchy or given a numerical weight that can be used to determine which service provider(s) get a larger share of the tip amount.

In some embodiments, the third party computing device can provide activity operator portals to multiple activity operators, thereby allowing the third party to facilitate collection and payment of tips to multiple activity operators. Each activity operator will have their own activity operator portal and thereby will be able to customize their corresponding activity participant input portal as described herein.

In the above detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure.

It is to be understood that the terminology used herein is for the purpose of describing particular embodiments only and is not intended to be limiting. As used herein, the singular forms “a”, “an”, and “the” include singular and plural referents, unless the context clearly dictates otherwise, as do “a number of”, “at least one”, and “one or more” (e.g., a number of occupied participant spots may refer to one or more occupied participant spots), whereas a “plurality of” is intended to refer to more than one of such things.

Furthermore, the words “can” and “may” are used throughout this application in a permissive sense (i.e., having the potential to, being able to), not in a mandatory sense (i.e., must). The term “include,” and derivations thereof, means “including, but not limited to”.

Although specific embodiments have been illustrated and described herein, those of ordinary skill in the art will appreciate that an arrangement calculated to achieve the same results may be substituted for the specific embodiments shown. This disclosure is intended to cover adaptations or variations of one or more embodiments of the present disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method, comprising:
providing, by a third party device, a tip collection function to an activity operator to collect a tip from a participant; and
using the tip collection function to:
offer to a plurality of participants, by the activity operator, a portal to allow the participants to each pay a tip for a service;
pay, to the third party via the portal, the tip by each participant electing to pay the tip;
aggregate, by the third party, a plurality of tips from the plurality of participants electing to pay the tip over a period of time; and
pay, by the third party, the aggregated plurality of tips from the plurality of participants to the activity operator.

2. The method of claim 1, further comprising determining, by the activity operator, one or more parameters of the tip.

3. The method of claim 2, wherein the parameters of the tip include:
a percentage of a cost of an activity;
a percentage of a total cost of the activity and add-ons to the activity; and
a flat rate.

4. The method of claim 2, further comprising paying, by a participant electing to pay the tip, the tip based on the parameters of the tip through the portal.

5. The method of claim 1, further comprising providing, by the activity operator to the participant, access to the portal to select tipping options provided by the activity operator.

6. The method of claim 1, further comprising selecting, by the activity operator, whether:
the tips are paid directly to service providers from the third party; or
the tips are aggregated and then an aggregated sum is paid to the activity operator to be disbursed to a plurality of service providers.

7. The method of claim 1, further comprising aggregating the tips based on:
a number of service providers; or
a role of each of the service providers;

8. The method of claim 7, further comprising determining, by the activity operator, an amount of the tips to pay each of the service providers.

9. An apparatus, comprising:
a computing device having a processor and a memory, wherein the computing device executes instructions stored in the memory to:
provide, by a third party device, a tip collection function to an activity operator to collect a tip from a participant; and
using the tip collection function to:
offer to a plurality of participants, by the activity operator, a portal to allow the participants to each pay a tip for a service;
pay, to the third party via the portal, the tip by each participant electing to pay the tip;
aggregate, by the third party, a plurality of tips from the plurality of participants electing to pay the tip over a period of time; and
pay, by the third party, the aggregated plurality of tips from the plurality of participants to the activity operator.

10. The apparatus of claim 9, wherein the tip collection function accepts payment of a single tip in multiple currencies.

11. The apparatus of claim 9, wherein the activity operator determines whether the participant pays a tip amount based on a percentage of a price of an activity or a percentage of a total price of the activity and add-ons to the activity.

12. The apparatus of claim 11, wherein the determination of whether the tip amount includes a percentage of the cost of the add-ons to the activity is based on the type of add-ons to the activity.

13. The apparatus of claim 11, wherein a service provider selects whether the participant tips before participating in the activity or after participating in the activity.

14. A non-transitory computer-readable medium having instructions stored thereon which, when executed by a processor, cause the processor to:
provide, by a third party device, a tip collection function to an activity operator to collect tips from a plurality of participants; and
use the tip collection function to:
offer to a plurality of participants, by the activity operator, a portal to allow the participants to each pay a tip for a service;
pay, to the third party via the portal, the tip by each participant electing to pay the tip;
aggregate, by the third party, a plurality of tips from the plurality of participants electing to pay the tip over a period of time; and
pay, by a third party, the aggregated plurality of tips from the plurality of participants to the activity operator.

15. The medium of claim 14, further comprising providing, to the activity operator, a report that includes information about a status of the tips.

16. The medium of claim 15, wherein the status of the tips includes an amount of outstanding tips, wherein the amount of outstanding tips includes tips collected by the third party that have not been paid to each of a plurality of service providers by the activity operator.

17. The medium of claim 16, wherein the report includes a status of tip payouts, wherein the status of the tip payouts includes:
the tips have not been paid to each service provider;
the tips are in transit to each service provider; or
the tips have been paid to each service provider.

18. The medium of claim 15, wherein the status of the tips includes dates on which the tips were paid to each of the service providers.

19. The medium of claim 15, further comprising displaying, by the report, a total of number of transactions that contributed to a total amount of outstanding tips.

20. The medium of claim 14, further comprising determining, by the tip collection function, which transactions are available for a tip payout.
